(19) United States
(12) Patent Application Publication
(10) Pub. No.: US 2016/0167385 A1
(43) Pub. Date: Jun. 16, 2016

(54) WASTE INK SPITTOON

(71) Applicant: HEWLETT-PACKARD DEVELOPMENT COMPANY, L.P., Houston, TX (US)

(72) Inventors: Xavier Gros Gras, Barcelona (ES); Paul Joseph Bruinsma, San Diego, CA (US); Xavier Gasso Puchal, Barcelona (ES)

(21) Appl. No.: 14/906,766

(22) PCT Filed: Sep. 30, 2013
(86) PCT No.: PCT/US2013/062590

§ 371 Date: Jan. 21, 2016

(51) Int. Cl. B41J 2/165

(52) U.S. Cl. CPC B41J 2/16505

(57) ABSTRACT

The present disclosure provides a waste ink spittoon for a printhead service station. The spittoon defines a reservoir for a waste ink composition ejected from a printhead. The spittoon comprises a gelling agent for increasing the viscosity of the waste ink composition, whereby the gelling agent comprises a particulate mass of solid particles of the gelling agent.

### BACKGROUND

Inkjet printing mechanisms include pens that eject drops of ink onto a substrate. Each pen has a printhead comprising nozzles through which the ink drops are fired. When the ink nozzles become obstructed or blocked, the print quality of the printer decreases. Accordingly, inkjet printers are provided with printhead service stations for servicing the printheads to reduce the risk of blockage.

Printheads are cleared by firing drops of ink through each of the nozzles in a process known as “spitting”. This waste ink is collected in a waste ink container or “spittoon” located in the printhead service station. A significant amount of waste ink can accumulate in the spittoon, particularly if the printer is subjected to a high volume of printing over a short period of time. If the printer is moved while the spittoon contains a substantial volume of waste ink, the waste ink can leak, for example, into the interior of the printer, damaging the printer's components. There is also a risk of spillage when the spittoon is removed from the printhead station, for example, when replacing the filled spittoon with an empty replacement.

To reduce the risk of spillage, absorbent pads formed, for example, of fabric or foam have been used in spittoons. Such absorbent pads are intended to soak up the ink, reducing the risk of spillage.

### DETAILED DESCRIPTION

Before particular examples of the present disclosure are disclosed and described, it is to be understood that the present disclosure is not limited to the particular devices, systems and methods disclosed herein. It is also to be understood that the terminology used herein is used for describing particular examples only and is not intended to be limiting, as the scope of protection will be defined by the claims and equivalents thereof.

In describing and claiming the devices, systems and methods, the following terminology will be used: the singular forms “a”, “an”, and “the” include plural referents unless the context clearly dictates otherwise. Thus, for example, reference to “a compartment” includes reference to one or more compartments.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight range of about 1 wt % to about 20 wt % should be interpreted to include not only the explicitly recited concentration limits of about 1 wt % to about 20 wt %, but also to include individual concentrations such as 2 wt %, 3 wt %, 4 wt %, and sub-ranges such as 5 wt % to 15 wt %, 10 wt % to 20 wt %, etc. All percentages are by weight (wt %) unless otherwise indicated.

It has been found that absorbent pads are not always effective for absorbing the waste ink and reducing the risk of waste ink spillage. For example, inks having a high latex content tend to form a crust on the upper surface of the absorbent pad, which can build-up and contact the printhead, clogging the print nozzles. Because of the high latex content of the ink, it has been found that the crust can be difficult to remove using conventional scraping techniques. The spittoons, methods and systems described herein provide at least an alternative way of reducing the risk of spillage of waste ink from the spittoon.

The present disclosure provides a waste ink spittoon for a printhead service station. The spittoon defines a reservoir for a waste ink composition ejected from a printhead. The spittoon comprises a gelling agent for increasing the viscosity of the waste ink composition, whereby the gelling agent comprises a particulate mass of solid particles of the gelling agent. In one example, the mass may be contained in an enclosure comprising a barrier layer that is rupturable or liquid-permeable to allow waste ink composition in the reservoir to contact the gelling agent.

The present disclosure also provides a system comprising a spittoon as described herein and an ink jet ink composition comprising latex in an amount of 3 to 12 weight %.

The present disclosure also relates to a method of clearing a printhead nozzle. The method comprises ejecting a waste ink jet ink composition from a printhead nozzle into a spittoon as herein described. In one example, the gelling agent interacts with the waste ink jet ink composition to form a non-flowing gel. For instance, the gelling agent may absorb liquid from the waste ink jet ink composition to form a solid gel.

As described above, the gelling agent comprises a particulate mass of solid particles of the gelling agent. In one example, the particulate mass is porous as a result of the interstices between the solid particles. These interstices may provide pathways for the flow of waste ink composition. In one example, the waste ink composition may flow through the gaps between the particles in the mass, for example, by capillary action. The particles of gelling agent may swell or expand as they absorb water from the waste ink composition. As the particles swell, they may separate from one another, and this can cause the particulate mass to expand to provide additional pathways for the flow of additional ink. The particulate nature of the gelling agent may also provide a high surface area of contact between the gelling agent and the waste ink composition. The gelling agent may remain in particulate form as it swells. In one example, the particulate mass is a free-flowing mass. For instance, at least some of the particles may be free to move relative to one another.

The gelling agent may be formed of a superabsorbent polymer (SAP). The superabsorbent polymer may be capable of absorbing up to about 1500 times, for example, up to about 1000 or about 1200 times its own weight of deionized and distilled water. For example, the superabsorbent polymer may be capable of absorbing up to about 800 times, for instance, up to about 500 or about 600 times its own weight of deionized and distilled water. In one example, the superabsorbent polymer may be capable of absorbing up to about 400 times, for instance, up to about 200 or about 300 times its own weight of deionized and distilled water. In one example, the superabsorbent polymer may be capable of absorbing at least about 20, for instance, at least about 30 times its own weight of deionized and distilled water. In another example, the superabsorbent polymer may be capable of absorbing at least about 40 times, for instance, at least about 50, about 60 or about 70 times its own weight of deionized and distilled water. In yet another example, superabsorbent polymer may be capable of absorbing at least about 100 times its own weight of deionized and distilled water. In one example, the superabsorbent polymer is a hydropolymer. The hydropolymer may absorb water from the waste ink composition to form a hydrogel.

In one example, the gelling agent comprises a hydropolymer, for instance, a water insoluble hydropolymer. The hydropolymer may absorb water from the waste ink composition. Any co-solvent in the waste ink composition may also be absorbed. This absorption may cause the hydropolymer to swell forming a solid, non-flowing gel. In one example, the absorption may increase the solids fraction of the remainder of the waste ink composition, causing its viscosity to increase (e.g. to form a non-flowing or solid residue). In one example, the solid components of the waste ink composition (e.g. pigment and/or latex particles) are not absorbed by the hydropolymer.

Where a hydropolymer is used as the gelling agent, the hydropolymer may be crosslinked. The hydropolymer may be a crosslinked hydropolymer network containing cations. Suitable cations include ammonium, lithium, sodium and/or potassium. In one example, the hydropolymer is a hydropolymer salt, for example, an ammonium, lithium, sodium or potassium salt. In one example, the hydropolymer is a crosslinked hydropolymer salt, for example, an ammonium, lithium, sodium or potassium salt. In one example, the hydropolymer may comprise carboxyl acid groups (—COOH) or carboxylate groups (e.g. —COO⁻M⁺, e.g. wherein M is NH₄⁺, Li⁺, Na⁺ or K⁺) along its polymer chain. In one example, the hydropolymer is a crosslinked hydropolymer comprising carboxyl acid groups (—COOH) along its polymer chain, wherein at least some of the carboxyl acid groups are neutralised and in salt form (e.g. ammonium, lithium, sodium or potassium salt form). The hydropolymer may be a polyacrylic acid, for example, a crosslinked polyacrylic acid. In one example, the hydropolymer may be a crosslinked polyacrylic acid salt, such as a crosslinked polyacrylic acid ammonium, lithium or potassium or sodium salt. In another example, the hydropolymer may be a polyacrylamide, for example, a crosslinked polyacrylamide. A mixture of two or more hydropolymers may be used. The hydropolymer may be a copolymer. For example, the hydropolymer may be a polyacrylic acid/polyacrylamide co-polymer. An example of a suitable hydropolymer is crosslinked poly(acrylic acid-co-acrylamide) potassium salt.

Where a particulate mass of gelling agent is employed, the gelling agent may be provided in any particulate form, for example, as beads, powder or granules. The mean particle size of the particles may be 1 mm to 5 mm in the dry, non-swollen form.

As discussed above, the spittoon may comprise an enclosure containing the gelling agent. For instance, the enclosure may retain the solid particles of gelling agent in place to prevent egress of the particles from the spittoon e.g. during transit or where the spittoon is inclined or shaken prior to installation. A plurality of enclosures containing the gelling agent may be provided. The enclosure(s) may be coupled to the spittoon, for example, using an adhesive (e.g. water-soluble adhesive) or other (e.g. mechanical) retaining means. The contents of the enclosure may consist essentially of solid particles of the gelling agent. In one example, the solid particles of the gelling agent form at least about 75% or about 80 weight %, for example, at least about 90% or at least about 95 weight % of the contents of the enclosure.

As described above, the enclosure may include a barrier layer that is rupturable or liquid-permeable to allow waste ink composition in the reservoir to contact the gelling agent. Where the barrier layer is a liquid-permeable barrier layer, the barrier layer may comprise a porous material. The porous material may take the form of a gauze or permeable membrane. The porous material may have apertures that are sized to allow the influx of waste ink composition to contact the gelling agent but that restrict or prevent egress of the solid particles of gelling agent into the remainder of the spittoon.

Where the barrier layer is a rupturable barrier layer, the barrier layer may be formed from a friable membrane or may include a seal that can be released by a simple manual action (e.g. a pull or push). In one example, the rupturable barrier layer is formed from a film of a water-soluble polymer that dissolves upon contact with the waste ink composition to allow the waste ink composition in the reservoir to contact the gelling agent. In another example, the enclosure may be formed from a film of water-soluble polymer. For example, the gelling agent may be contained in a pouch formed from a film of the water-soluble polymer. Any suitable water-soluble polymer may be employed to form the barrier layer. An example of a water-soluble polymer is polyvinyl alcohol (PVA).

The spittoon may be provided with a compartment for receiving the gelling agent. In one example, a plurality of compartments is provided. For instance, a wall (e.g. base) of the spittoon may define a compartment for receiving the gelling agent. The compartment may be sealed with a barrier layer, such that the compartment and barrier layer form an enclosure containing the particles of the gelling agent.

Alternatively, a wall (e.g. base) of the spittoon may define a compartment for receiving an enclosure containing the particles of the gelling agent. In one example, the spittoon comprises a plurality of compartments for receiving the gelling agent or an enclosure containing the gelling agent.

After the gelling agent has contacted the waste ink composition, the gelling agent may be dried, for example, when the printer or printhead service station is idle. As a result of drying, liquid (e.g. water and/or co-solvent) absorbed by the gelling agent may be evaporated. In one example, this re-generates the gelling agent, allowing it to absorb water and/or co-solvent from any fresh waste ink introduced into the spittoon (e.g. in a subsequent spitting cycle). The drying effect may be achieved by evaporation under ambient conditions. It is possible, however, for the gelling agent to be dried using a heater or a fan. Such a heater or fan may be provided as part of or as an attachment to the spittoon. A drying agent may also be provided to aid the drying process.

As discussed above, the present disclosure also relates to a system comprising a spittoon as described herein and an inkjet ink composition comprising a latex content of about 3 to about 12 weight %. By latex content, it is meant the content of latex polymer in the inkjet ink composition.

The ink jet ink composition may be an aqueous composition. The ink jet ink composition may comprise pigment, latex, water and co-solvent. The pigment may form about 0.1 to about 10 weight %, for example, about 0.2 to about 6 weight % or about 0.4 to about 4 weight % of the ink jet ink composition. Any suitable pigment may be employed. Examples of suitable pigment colours include black, cyan, magenta, yellow, light cyan and light magenta.

The inkjet ink composition comprises about 3 to about 12 weight %, for example, from about 5 to about 10 weight % latex. In one example, the latex content is about 6 to about 8 weight %. The latex may comprise polymeric particulates from 20 nm to 500 nm (and often from 100 nm to 300 nm) in size. Such polymeric particulates can comprise a plurality of monomers that are polymerized, and can also be crosslinked. In one example, the polymeric particulates are particulates of an anionic polymer.

Latex polymers can be prepared using any of a number of known emulsion polymerization techniques where co-monomers are dispersed and polymerized in a discontinuous phase of an emulsion. Monomers that are often used include ethyl acrylate; ethyl methacrylate; benzyl acrylate; benzyl methacrylate; propyl acrylate; propyl methacrylate; iso-propyl acrylate; iso-propyl methacrylate; butyl acrylate; butyl methacrylate; hexyl acrylate; hexyl methacrylate; octadecyl methacrylate; octadecyl acrylate; lauryl methacrylate; lauryl acrylate; hydroxyethyl acrylate; hydroxyethyl methacrylate; hydroxyhexyl acrylate; hydroxyhexyl methacrylate; hydroxyoctadecyl acrylate; hydroxyoctadecyl methacrylate; hydroxylauryl methacrylate; hydroxylauryl acrylate; phenethyl acrylate; phenethyl methacrylate; 6-phenylhexyl acrylate; 6-phenylhexyl methacrylate; phenyllauryl acrylate; phenyllauryl methacrylate; 3-nitrophenyl-6-hexyl methacrylate; 3-nitrophenyl-18-octadecyl acrylate; ethyleneglycol dicyclopentyl ether acrylate; vinyl ethyl ketone; vinyl propyl ketone; vinyl hexyl ketone; vinyl octyl ketone; vinyl butyl ketone; cyclohexyl acrylate; methoxysilane; acryloxypropyhiethyldimethoxysilane; trifluoromethyl styrene; trifluoromethyl acrylate; trifluoromethyl methacrylate; tetrafluoropropyl acrylate; tetrafluoropropyl methacrylate; heptafluorobutyl methacrylate; iso-butyl acrylate; iso-butyl methacrylate; 2-ethylhexyl acrylate; 2-ethylhexyl methacrylate; iso-octyl acrylate; and iso-octyl methacrylate.

As mentioned above, the ink jet ink composition may include a co-solvent. The co-solvent may be present in an amount of about 15 to about 30 weight %, for example, about 20 to 25 weight % of the ink jet ink composition. In one example, the co-solvents prevent the print nozzles from clogging due to evaporation of water. Suitable co-solvents include organic solvents including aliphatic alcohols, aromatic alcohols, diols, triols, glycol ethers, poly(glycol) ethers, lactams, formamides, acetamides, long chain alcohols, ethylene glycol, propylene glycol, diethylene glycols, triethylene glycols, glycerine, dipropylene glycols, glycol butyl ethers, polyethylene glycols, polypropylene glycols, amides, ethers, carboxylic acids, esters, organosulfides, organosulfoxides, sulfones, alcohol derivatives, carbitol, butyl carbitol, cellosolve, ether derivatives, amino alcohols, and ketones.

The inkjet ink composition may also include optional components, including surfactants and wax dispersants.

The inkjet ink composition comprises water. Water may be the main component. In one example, the inkjet ink composition comprises at least 50 weight % water, for example, at least 60 weight % water. In one example, the inkjet ink composition comprises about 60 to 70 weight % water.

The inkjet ink composition may be used in combination with a pre-treatment composition. The pre-treatment composition may be applied to the media substrate as a first layer but may also be printed with the ink in multiple passes. In one example, the pre-treatment composition increases the viscosity of the inkjet ink composition, thereby reducing the risk of the ink bleeding or coalescing on the media substrate before the printed image is heated and cured. The pre-treatment composition may include a surfactant and a solvent.

Suitable solvents for the pre-treatment composition include the co-solvents mentioned above. For instance, suitable solvents for the pre-treatment composition include aliphatic alcohols, aromatic alcohols, diols, triols, glycol ethers, poly(glycol) ethers, lactams, formamides, acetamides, long chain alcohols, ethylene glycol, propylene glycol, diethylene glycols, triethylene glycols, glycerine, dipropylene glycols, glycol butyl ethers, polyethylene glycols, polypropylene glycols, amides, ethers, carboxylic acids, esters, organosulfides, organosulfoxides, sulfones, alcohol derivatives, carbitol, butyl carbitol, cellosolve, ether derivatives, amino alcohols, and ketones.

In one example, the surfactant in the pre-treatment composition is a cationic polymer, for instance, a cationic polyamine (Floquart FL-2350, SNF France). Since the printhead nozzle is used to dispense the inkjet ink composition as well as the pre-treatment composition, the waste inkjet ink composition ejected into the spittoon may include the pre-treatment composition. Accordingly, in some examples, the waste inkjet ink composition may additionally comprise a cationic polymer, for example, a cationic polyamine.

The spittoon as described herein may be used in a printhead service station. Accordingly, the present disclosure may also include a printhead service station comprising a spittoon as described herein. The printhead service station may also include an inkjet pen capping device. Such a capping device may protect the printhead nozzles from contaminants and drying. The printhead service station may also include a printhead wiper. Such wipers may be used to remove ink residue, dust and debris from the printhead.

In one example, a cassette comprising an inkjet pen capping device, a printhead wiper and a spittoon as described herein may be provided. Such a cassette may be releasably coupled to an inkjet printer for use as the printhead service station. Such a cassette may be removed and replaced with a new cassette when necessary.

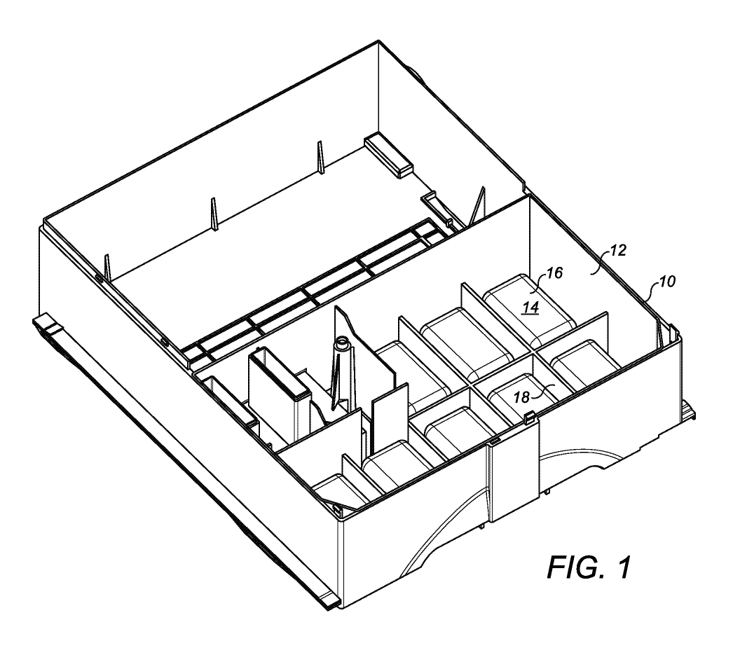

FIG. 1 depicts, by way of illustration, a waste ink spittoon according to an example of a spittoon of the present disclosure.

The waste ink spittoon 10 defines a reservoir 12 for a waste ink composition ejected from a printhead (not shown). The spittoon comprises a gelling agent 14. In the depicted example, the gelling agent 14 is contained in an enclosure 16 formed of a water-soluble polymer (e.g. PVA). The gelling agent is a particulate mass comprising solid particles of the gelling agent. In one example, the gelling agent is a particulate mass comprising solid particles of crosslinked poly(acrylic acid-co-acrylamide) potassium salt.

A plurality of enclosures 16 may be provided. As shown in the Figure, the spittoon 10 may be provided with a plurality of recesses or compartments 18 for receiving the enclosures 16.

The water-soluble polymer enclosure may form a barrier layer that encloses the gelling agent 14. In the depicted example, the barrier layer contains the gelling agent 14, preventing it from being spilled into the remainder of the spittoon 10.

In use, a waste ink composition ejected from a printhead nozzle (not shown) is introduced into the spittoon 10. Water contained in the waste ink composition dissolves the water-soluble polymer, causing it to rupture. This allows the waste ink composition to contact the gelling agent. In one example, the gelling agent absorbs water from the waste ink composition. This increases the solids content of the remainder of the waste ink composition, thereby raising its viscosity to form a non-flowing or solid residue.

### EXAMPLE 1

In this example, 0.342 g of polyacrylic acid-co-acrylamide potassium salt granules were placed in a petri dish as a particulate mass of solid particles of a gelling agent. 6 ml of an ink jet ink composition was gradually pipetted onto the granules. Most of the liquid from the ink jet ink composition was absorbed immediately. After one hour, the liquid was fully absorbed, leaving a bed of swollen granules. After 16 hours, the granules had shrunk back from the sides of the petri dish.

An additional 1 ml of the ink jet ink composition was added to the granules. Liquid from the ink was readily absorbed. As the granules swell, they expand to provide additional pathways for the additional ink.

The granules were then left to dry for approximately three days. An additional 2 ml of the ink jet ink composition was added to the dried granules. After 7 minutes, some of the liquid had been absorbed. After 18 minutes, the ink no longer flowed. After 1 hour and 18 minutes, there was no discernible liquid in the petri dish. This illustrates that the granules can be re-generated and re-used.

### EXAMPLE 2

In this example, 0.36 g of poly(acrylic acid) partial sodium salt-graft-poly(ethylene oxide) granules were placed in a petri dish as a particulate mass of solid particles of a gelling agent. 6 ml of an ink jet ink composition was gradually pipetted onto the granules. Some of the liquid from the ink jet ink composition was absorbed immediately. After one hour, the liquid was fully absorbed.

### EXAMPLE 3

In this example, a mixture of magenta ink and a solution of a cationic polyamine (Floquart FL-2350, SNF France) was mixed with polyacrylic acid-co-acrylamide potassium salt granules. This caused the granules to swell with liquid from the ink. The granule and ink mixture was then smeared onto a white vinyl media. The swollen granules were not significantly pigmented, indicating that the pigment remained substantially unabsorbed by the hydropolymer as it swelled.

### Comparative Example

In this example, 100 g of solid particles of polyacrylic acid-co-acrylamide potassium salt were dispersed and deposited onto a fabric to form a composite comprising particles dispersed throughout a fabric substrate. The resulting composite was placed in a spittoon. 900 cm³ of a waste ink composition was deposited onto the fabric in a series of doses. The initial dose of ink was absorbed by the fabric and absorbed by the hydropolymer particles to form a gel. The gel blocked the pores of the composite and, as a result, subsequent doses of ink could no longer be absorbed.

1. A waste ink spittoon for a printhead service station, said spittoon defining a reservoir for a waste ink composition ejected from a printhead, wherein said spittoon comprises a gelling agent for increasing the viscosity of the waste ink composition, whereby the gelling agent comprises a particulate mass of solid particles of the gelling agent.

2. A spittoon as claimed in claim 1, wherein the particulate mass is contained in an enclosure comprising a barrier layer that is rupturable or liquid-permeable to allow waste ink composition in the reservoir to contact the gelling agent.

3. A spittoon as claimed in claim 1, wherein the gelling agent is capable of absorbing at least 50 times its own weight of deionized and distilled water.

4. A spittoon as claimed in claim 1, wherein the gelling agent comprises a hydropolymer.

5. A spittoon as claimed in claim 4, wherein the hydropolymer is a crosslinked hydropolymer network containing cations selected from ammonium, lithium, sodium and potassium.

6. A spittoon as claimed in claim 4, wherein the hydropolymer is a homopolymer or a copolymer.

7. A spittoon as claimed in claim 6, wherein the hydropolymer is a polyacrylic acid, a polyacrylic acid salt and/or a polyacrylamide

8. A spittoon as claimed in claim 7, wherein the hydropolymer is a crosslinked poly(acrylic acid-co-acrylamide) potassium salt.

9. A spittoon as claimed in claim 2, wherein the barrier layer is a rupturable barrier layer formed from a film of a water-soluble polymer that dissolves upon contact with the waste ink composition to allow the waste ink composition in the reservoir to contact the gelling agent.

10. A spittoon as claimed in claim 9, wherein the enclosure is formed from the film of the water-soluble polymer.

11. A spittoon as claimed in claim 2, wherein the spittoon is provided with a compartment for receiving the enclosure.

12. A spittoon as claimed in claim 2, wherein the spittoon is provided with a compartment whose wall(s) define at least part of the wall(s) of the enclosure.

13. A system comprising a spittoon as claimed in claim 1 and an ink jet ink composition comprising latex in an amount of at least 3 to 12 weight %.

14. A method of clearing a printhead nozzle, said method comprising ejecting a waste ink jet ink composition from a printhead nozzle into a spittoon as claimed in claim 1.

15. A method as claimed in claim 14, wherein the gelling agent reacts with the waste ink jet ink composition to form a non-flowing gel.
